(19) United States
(12) Patent Application Publication
(10) Pub. No.: US 2006/0203289 A1
(43) Pub. Date: Sep. 14, 2006

(54) Printing system, printer and storage medium readable by computer

(75) Inventor: Yuji Miyata, Aichi-ken (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 11/362,178

(22) Filed: Feb. 27, 2006

(30) Foreign Application Priority Data
Feb. 28, 2005 (JP) P2005-053403

(51) Int. Cl. G06K 15/00

(52) U.S. Cl. 358/1.18; 358/1.15

(57) ABSTRACT

A printing system includes: a first unit that generates first printing data corresponding to a first image to print to one surface of recording medium and second printing data corresponding to a second image to print to the other surface thereof; a second unit that adds, to the first and second printing data, identification information representing a relationship between the two printing data; a third unit that prints the first image to the one surface; a fourth unit that prints an image to a recording medium put on a paper feeding unit; and a fifth unit that determines, when a print is requested based on printing data for printing to a recording medium put on the paper feeding unit after printing the first image to the one surface, whether or not identification information related to the identification information is added to the printing data.

### CROSS-REFERENCE TO RELATED APPLICATIONS

This application is based on and claims the benefit of priority from the prior Japanese Patent Application No. 2005-53403, filed on Feb. 28, 2005; the entire contents of which are incorporated herein by reference.

### TECHNICAL FIELD

The present invention relates to a printing system for printing an image represented by printing data to a recording medium, and a printer and program constituting the same.

### BACKGROUND

Conventionally, there is known a printing system that information processors., such as personal computers (hereinafter, referred to as PCs), and a printer are connected together through a communication line so that the printing data, sent from the information processor through the communication line, can be received at the printer end, to thereby print an image represented by the printing data to a recording paper.

Where the user makes a printing by utilization of a printing system configured as above, he/she possibly desires to make a printing as to the printing data from the PC to both surfaces of a recording paper due to the reason to save recording papers or so. In such a case, it is easy to perform a double-sided printing, if on the printer is provided a double-sided printing device capable of automatically performing a printing to both surfaces by merely sending double-sided printing data from the PC.

However, the double-sided printing device, capable of making an automatic printing to both surfaces of a recording paper, is complicated in structure and not cheap in price. For this reason, it cannot be considered as a general-purpose device because to be mounted only on certain models or set up as an optional mechanism desirably extended by user's decision instead of installed on a standard basis.

Contrary to this, there is a scheme called manual-feed double-sided printing, as a method to perform a printing to both surfaces of a recording paper without the use of a double-sided printing device. By using such a manual-feed double-sided printing function, double-sided printing can be realized despite of the requirement of an intervening user's manual operation.

Explaining concretely the manual-feed double-sided printing function by exemplifying the foregoing printing system, where to perform a printing as to the printing data generated at the PC to both surfaces of a recording paper by use of the double-sided printing function, the printing data corresponding to an image to print to one surface is first sent from the PC to the printer. Thereupon, the printer received it makes prints of an image represented by the printing data (one surface side) to one surface of the recording paper. Thereafter, the user himself/herself goes to the printer and overturns the recorded paper printed at one surface and again put it onto the printer. In this case, it generally is relocated to a manual-feed tray.

Then, the user comes back to the PC so that he/she operates, e.g. by clicking, a predetermined button on a monitor screen thereby informing the PC of a completed relocation of the recording paper. This allows the PC to send the printing data corresponding to an image to print to the remaining opposite surface. In response, the printer can print an image represented by the printing data (opposite surface side) to the relocated recording paper. On this occasion, the relocated recording paper is already printed with the image at its one surface. Thus printing is made to the opposite surface free of prints at all, thus completing the manual-feed double-sided printing.

Various proposals have been conventionally made as to such manual-feed double-sided printing functions, along with a number of proposals of various techniques to enhance such functions. For example, there is known a technique that, when printing is completed to one surface of a recording paper and then the user relocates the recording paper, the user is displayed in what way the paper is to be relocated to a paper-feed port, in consideration of image orientation to the paper, paper-feed port, plane and direction and binding position, etc. This allows the user to make a double-sided printing in a manner of binding a desired image in a desired orientation by relocating the paper according to the display (see JP-A-11-20272).

### SUMMARY

However, in a printing system where a printer and plural personal computers are connected together through a network or the printer is connected to only one of the PCs wherein a relevant printer is set up common for a plurality of PCs to make a printing, the users are allowed to use the printer.

In such a situation, when a certain user A performs a manual-feed double-sided printing while another user B is to make a printing, there is a possibility to encounter a trouble. Namely, when printing is completed as to the one-surface printing data sent by the user A and the user A, after relocated the recording paper, is to transmit opposite-surface printing data, if the other user B sends printing data to the printer before that transmission, a printing is made as to the printing data the user B has sent, to the opposite surface of the relocated recording paper.

Namely, depending upon the timing of printing (transmission timing of printing data) of the both, an image of the printing data sent by the user A is printed to the one surface of the recording paper while an image of the printing data sent by the user B is printed to the opposite surface thereof. Thus, the both users A, B are not to obtain desired printing results.

In order to avoid such problems, where user A is performing a manual-feed double-sided printing, after the user A completed to relocate the recording paper printed at one surface, there is a need for another user noticeably not to send printing data until a printing, for the user A, is started to the opposite surface.

The present invention has been made in view of the above problem and provides a printing system allowing the user who makes a manual-feed double-side printing to positively print a desired image to both surfaces of a recording paper, a printer having the printing system, and a storage medium readable by a computer.

According to an aspect of the invention, a printing system includes: a print-data generating unit that generates first printing data corresponding to a first image to print to one surface of recording medium and second printing data corresponding to a second image to print to the other surface of the recording medium; an identification-information adding unit that adds, to the first and second printing data generated by the print-data generating unit, identification information representing a relationship between the first printing data and the second printing data; a first printing unit that prints the first image represented by the first printing data to the one surface of the recording medium; a second printing unit that prints an image to a recording medium put on a paper feeding unit; and an identification-information determining unit that determines, when a print is requested based on printing data for printing to a recording medium put on the paper feeding unit after printing the first image represented by the first printing data to the one surface of the recording medium by the first printing unit, whether or not identification information related to the identification information added to the first printing data is added to the printing data; and the second printing unit performs a printing as to the printing data for printing to the recording medium put on the paper feeding unit after printing the first image to the one surface of the recording medium by the first printing unit, when the identification-information determining unit determines that the identification information added first printing data is added to the printing data.

According to another aspect of the invention, a printer includes: a print-data generating unit that generates first printing data corresponding to a first image to print to one surface of recording medium and second printing data corresponding to a second image to print to the other surface of the recording medium; an identification-information adding unit that adds, to the first and second printing data generated by the print-data generating unit, identification information representing a relationship between the first printing data and the second printing data; a first printing unit that prints the first image represented by the first printing data to the one surface of the recording medium; a second printing unit that prints an image to a recording medium put on a paper feeding unit; and an identification-information determining unit that determines, when a print is requested based on printing data for printing to a recording medium put on the paper feeding unit after printing the first image represented by the first printing data to the one surface of the recording medium by the first printing unit, whether or not identification information related to the identification information added to the first printing data is added to the printing data; and the second printing unit performs a printing as to the printing data for printing to the recording medium put on the paper feeding unit after printing the first image to the one surface of the recording medium by the first printing unit, when the identification-information determining unit determines that the identification information added first printing data is added to the printing data.

According to another aspect of the invention, a storage medium readable by a computer, the storage medium storing a program of instructions executable by the computer to perform a function for printing, the function, including: generating first printing data corresponding to a first image to print to one surface of recording medium and second printing data corresponding to a second image to print to the other surface of the recording medium; adding, to the first and second printing data, identification information representing a relationship between the first printing data and the second printing data; printing the first image represented by the first printing data to the one surface of the recording medium; printing an image to a recording medium put on a paper feeding unit; and determining, when a print is requested based on printing data for printing to a recording medium put on the paper feeding unit after printing the first image represented by the first printing data to the one surface of the recording medium by the first printing unit, whether or not identification information related to the identification information added to the first printing data is added to the printing data; and performing a printing as to the printing data for printing to the recording medium put on the paper feeding unit after printing the first image to the one surface of the recording medium by the first printing unit, when the identification-information determining unit determines that the identification information added first printing data is added to the printing data.

### BRIEF DESCRIPTION OF THE DRAWINGS

These and other objects and advantages of this invention will become more fully apparent from the following detailed description taken with the accompanying drawings in which:

FIG. 1 is a block diagram showing a schematic structure of a printing system overall according to an illustrative aspects;

FIG. 2 is a schematic explanatory view of a printer constituting the printing system according to the illustrative aspects;

FIG. 3 is a functional block diagram of a printing system according to the illustrative aspects;

FIG. 4 is a flowchart representing a print-data transmission process to be executed by a PC according to the illustrative aspects;

FIG. 5 is a flowchart representing the detail of a manual-feed double-sided printing process at S140 in a FIG. 4 print-data transmission process;

FIG. 6 is a flowchart representing the detail of a timeout process at S350 in a FIG. 5 manual-feed double-sided printing process;

FIG. 7 is an explanatory figure representing a display example for instructing the user to relocate a recording paper;

FIG. 8 is an explanatory figure representing a display example for inquiring the user to resume an opposite-surface printing after timeout;

FIG. 9 is an explanatory figure representing a display example for instructing the user to relocate a recording paper after timeout;

FIG. 10 is a flowchart representing a data receiving process to be executed on the printer according to the illustrative aspects;

FIG. 11 is a flowchart representing the detail a print-job process at S560 in a FIG. 10 data receiving process.

FIG. 12 is a flowchart representing the detail of a tray-to-use select process at S680 in a FIG. 11 print job process;

FIG. 13 is a flowchart representing the detail of a hold-data printing process at S730 in a FIG. 11 print job process;

FIG. 14 is a flowchart representing the detail of a print-cancel process at S520 in a FIG. 10 data receiving process; and

FIG. 15 is a flowchart representing the detail of a pseudo single-sided printing process at S540 in a FIG. 10 data receiving process.

### DESCRIPTION OF THE ILLUSTRATIVE ASPECTS

Illustrative aspects will now be explained below by referring the accompanying drawings.

<Printing System Overall Arrangement>

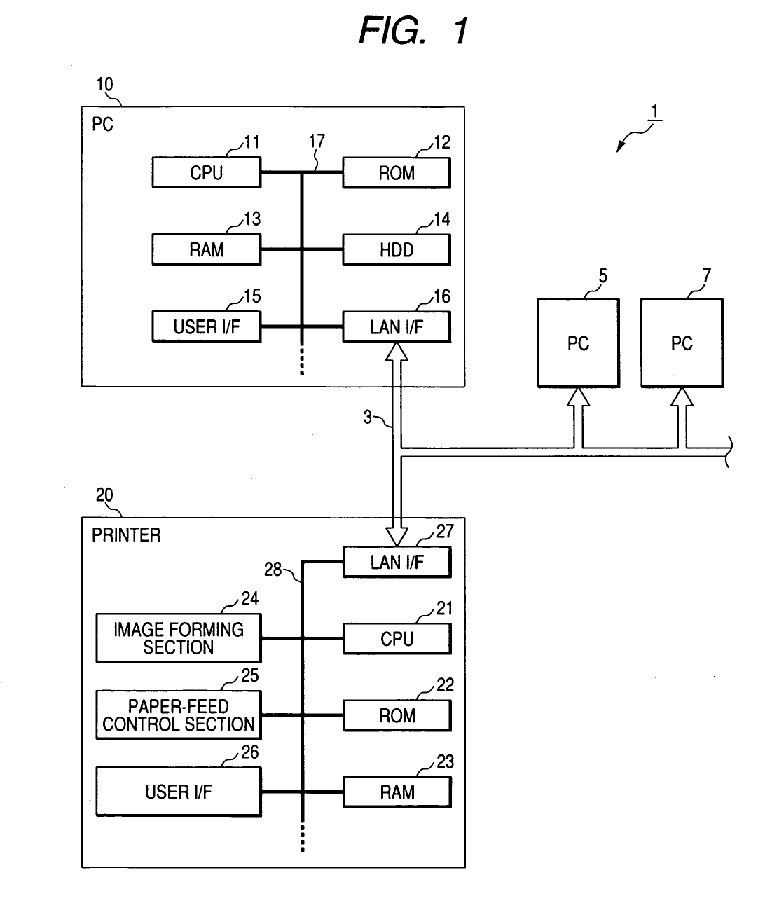

FIG. 1 is a block diagram showing the overall schematic arrangement of a printing system according to an illustrative aspect. As shown in FIG. 1, the printing system 1 is configured connecting, for exchanging data, between a plurality of PCs 10, 5, 7 . . . as information processing apparatuses and a printer 20 as a printing apparatus through a network 3 as a communication line. Incidentally, the network 3 is a LAN (local area network) in the illustrative apect.

The PC 10 has a CPU 11 for performing various operations, a ROM 12 storing the programs, data, etc. for various processes, referred later, a RAM 13 for temporarily storing various ones of data for the CPU 11 to execute an operation processing, a hard disk drive (HDD) 14 storing various ones of software including an OS (operating system), a printer driver and application programs and for temporarily saving (spooling) printing data, an user interface 15 having an operation key, a liquid-crystal display, etc. not shown, and a LAN interface 16 for communication with the printer 20 or other PCs 5, 7 . . . through the network 3. Those are connected one with another, for conveying data, through a bus 17.

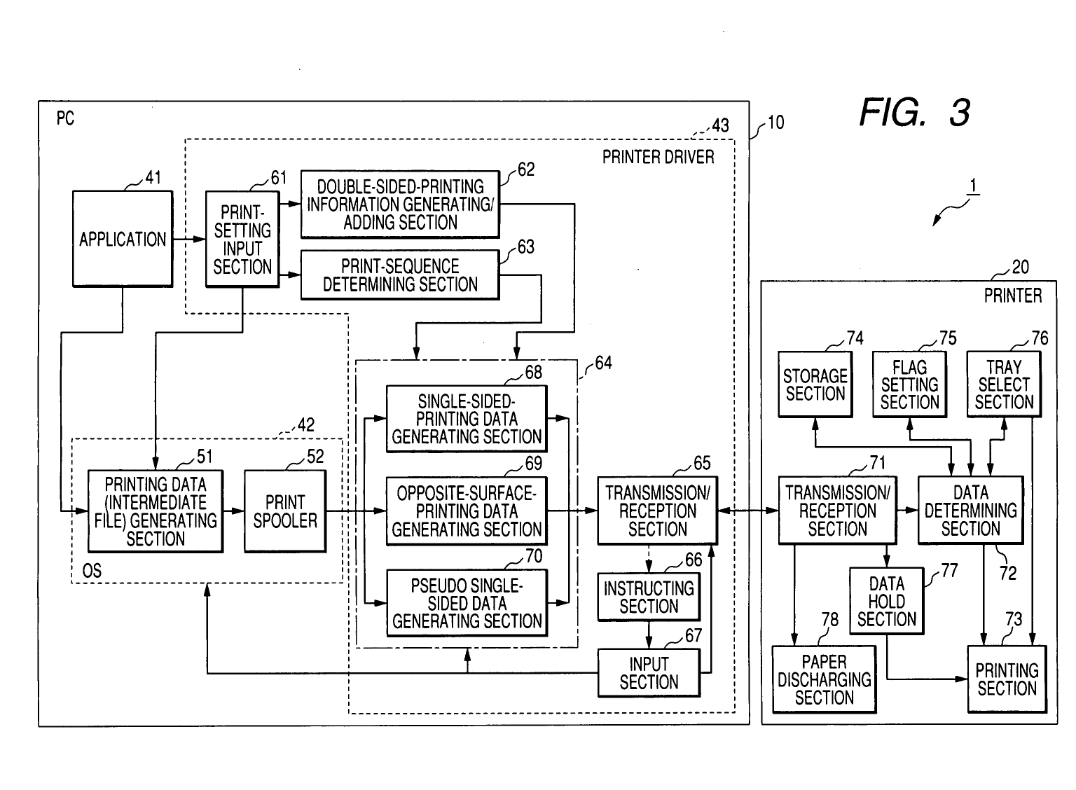

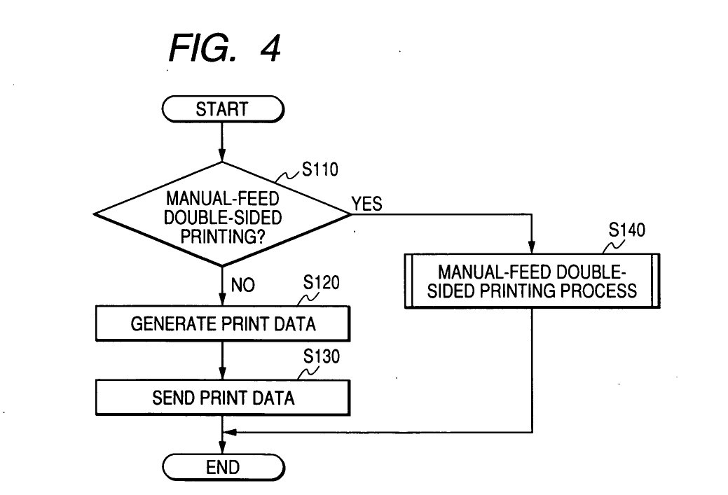

The PC 10, at its CPU 11, is to execute the programs stored in the ROM 12, thereby realizing the functions shown in FIG. 3, specifically the processes shown by the flowcharts of FIGS. 4 to 6, referred later. The other PCs 5, 7 . . . are basically the same configuration as the foregoing PC 10, and hence omitted to explain the detail thereof.

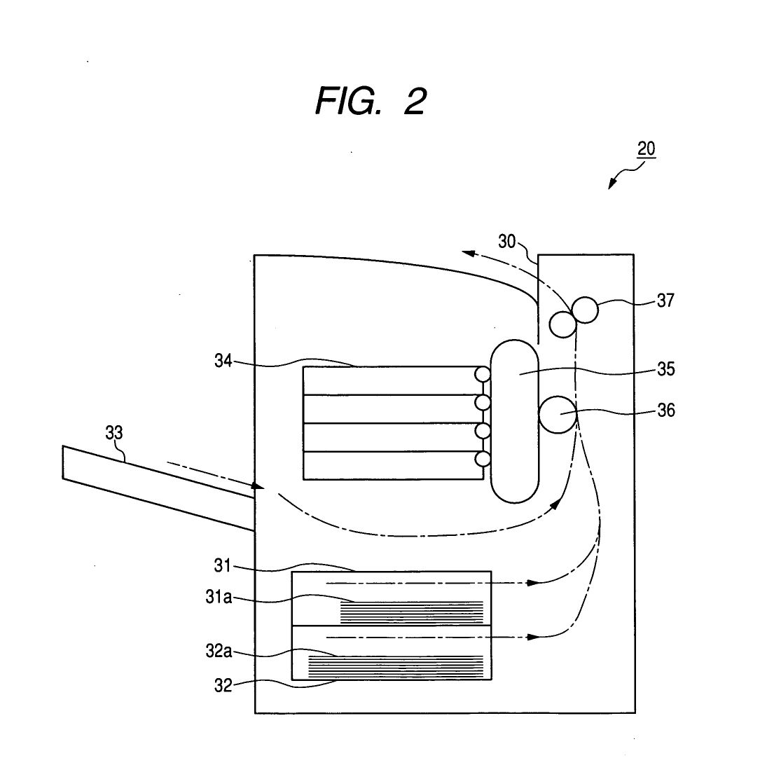

Meanwhile, the printer 20 has a CPU 21 for performing various controls, a ROM 22 storing the programs, data, etc. of various control processes for the CPU 21 to execute, a RAM 23 for temporarily storing data during execution of the control program by the CPU 21, an image forming section 24 for printing an image to a recording paper according to the command of from the CPU 21, paper-feed control section 25 for selectively supplying the recording paper put in paper trays 31, 32, referred later, or a manual-feed tray 33 (see FIG. 2, as to the both), a user interface 26 having an operation key, a liquid-crystal display, etc., not shown, and a LAN interface 27 for communication with the PCs 10, 5, 7 . . . through the network 3. Those are connected one with another, for exchanging data, through a bus 28.

When the CPU 21 externally receives print-job data from the PC 10, 5, 7 . . . , it performs control of the image forming section 24, feed-paper control section 25, etc. according to the print-job data, thereby forming an image based on the image data to a desired recording paper. Note that print-job data includes various pieces of information related to a print job, e.g. paper type and paper tray type besides printing data representative of an image to print.

According to the illustrative aspect, the printer 20 has the existing manual-feed double-side-printing function to print an image to both surfaces of one recording paper while intervening user's manual operation, in addition to the usual printing function to print a page of image to one recording paper. When the user instructs a manual-feed double-sided printing to the PC 10, the PC 10 generates print-job data in accordance therewith. In such a case, print-job data is sent to the printer 20 by being added with information as printing data corresponding to double-sided printing, a unique job ID set solely for the relevant job, and terminal name of PC 10, besides printing data. The detail is referred later.

<Printer Overall Structure>

Based on FIG. 2, explanation is now made on the various mechanism structures related to image forming in the printer 20. FIG. 2 is a schematic explanatory view of the printer 20 constituting the printing system 1 according to the illustrative aspect.

According to the illustrative aspect, the printer 20 is a color laser printer of the electro-photographic scheme arranged to irradiate an image to the drum by use of a laser and fix a toner to a recording paper.

Namely, the printer 20 has a toner unit 34 that contains toners in various colors and has a developing unit, etc. to develop toner onto a drum unit 35, a drum unit 35 that forms an electrostatic latent image due to illumination of the laser light from a laser write unit (not shown) after being electrically charged by an electrifier (not shown) and put toner thereon, a transferer 36 that a toner image formed on the drum unit 35 is transferred, and a fixing unit 37 that fixes the toner image transferred from the transferer 36 to a recording paper.

The printer 20 has, as paper tray, a first paper tray 31 and second paper tray 32 accommodated within the printer 20. Besides, it also has a manual-feed tray 33 having a paper cassette exposed outside so that the user can place a recording paper directly thereon. In the printer 20 of this embodiment, the first paper tray 31 receives a stack of B5-size recording papers 31a while the second paper tray 32 receives a stack of A4-size recording papers 32a.

The PC 10 is allowed to select which one of the paper trays is to use, in sending printing data. Specifically, the user is allowed to select any of “auto tray select” mode that allows the printer to automatically select a paper tray suited for a recording paper size to print, “manual feed tray” mode for designating the manual feed tray 33, and “first paper tray” and “second paper tray” modes directly designating any of the first and second paper trays 31, 32.

However, note that the paper tray, for relocating a recording paper printed at one surface and to be printed at the opposite surface upon performing double-sided printing by the manual-feed double-sided printing function, is fixed on the manual feed tray 33 in the illustrative aspect. The user is not allowed to select it freely. This however is mere one example, i.e. it is natural to provide a structure allowing the user to select a designation-of-relocation for a printing to the opposite surface.

Consequently, when printing data is sent from the PC 10, the printing data is added with information indicative of which one of the paper trays is to use. Meanwhile, when the user designated for a manual-feed double-sided printing, there is added information representative of manual-feed double-sided printing. Receiving it, the printer 20 is known of printing data for manual-feed double-sided printing, so that it can perform a printing to the recording paper put in the manual-feed tray 33 when printing the opposite surface.

At the printer 20 received the printing data, a recording paper is fed/transported from the paper tray designated or selected, and printed with an image through the transferer 36, the fixing unit 37, etc., followed by being discharged at a paper exit 30.

<Printing System Function>

Based on FIG. 3, explanation is now made on the function to be realized on the printing system 1 according to the illustrative aspect. FIG. 3 is a block diagram of a printing system according to the illustrative aspect, which particularly represents the function to execute a manual-feed double-sided printing.

As already noted, the HDD 14 of the PC 10 is stored with various ones of software, including OS 42, printer driver 43 and application 41. The printer driver 43 and the application 41 are software to be executed under the domination of the OS 42.

When the user instructs to print the data (e.g. document data) prepared by using the application 41, a print-setting input section 61 of the printer driver 43 prompts the user to input various pieces of information for printing. The user here is allowed to input various settings, e.g. whether to or not to perform a manual-feed double-sided printing, which tray is set up to use, which paper size is set for use, and in what degree of resolution is to set.

After inputting various settings to the print-setting input section 61, printing data generation is started. When the user makes a setting of manual-feed double-sided printing, a double-sided print information generating/adding section 62 of the printer driver 43 generates various pieces of information about manual-feed double-sided printing. Specifically, generated are information indicative of manual-feed double-sided printing, a job ID unique to the manual-feed double-sided printing, a terminal name of the PC 10, and an actual number of recording sheets to perform a double-sided printing. Then, a print-sequence determining section 63 determines a sequence of printing. This determines a page of image to print on one side and the order thereof, and a page of image to print on the opposite surface and the order thereof.

Meanwhile, cooperatively with the application 41, a print-data generating section 51 provided by the OS 42 generates an intermediate file (EMF: enhanced meta file) that is printing data not relying upon printer type. Specifically, a program module GDI (graphics device interface) provided by the OS 42 produces a device context as a virtualized display domain and supplies it to the application 41. Due to this, a rendering process to the device context is performed by the application 41 with a result that page-based printing data (enhanced meta data) is generated. The printing data generated by the print-data generating section 51 is spooled in the HDD 14 by a print spooler 52 provided by the OS 42.

Here, in the case a manual-feed double-sided printing is instructed by the user, a single-sided printing data generating section 68 in a double-sided printing data generating section 64 of a printer driver 43 generates single-sided printing data (which serves as “first printing data”) that is printing data corresponding to an image to print to one surface of a recording paper, according to the printing data spooled. The generation is according to the order of printing determined by the printing-sequence determining section 63. Furthermore, the generated single-sided printing data is added with various pieces of information generated by the double-sided printing information generating/adding section 62.

The single-sided printing data thus with various pieces of information is sent to the printer 20 by a transmission/reception section 65.

At the printer 20, when its transmission/reception section 71 receives the single-sided printing data from the PC 10, a data determining section 72 analyzes the data. In the case there is included information indicative of manual-feed double printing, a flag setting section 75 sets the printer 20 in a manual-feed double-printing mode while a storage section 74 stores the job ID added to the single-sided printing data. Then, a tray selector section 76 selects a paper tray. A printing section 73 performs a printing to a recording paper received in the selected paper tray.

Meanwhile, at the PC 10 end sent the single-sided printing data, an instructing section 66, after the transmission, instructs the user to relocate the recording paper printed at one surface to the manual-feed tray 33. In response, the user who relocated the recording paper printed at one surface inputs a fact of completion of paper setting to an input section 67, an opposite-surface printing data generating section 69 generates opposite-surface printing data (which serves as “second printing data”) corresponding to an image to print to the opposite surface according to the printing data (intermediate file) spooled in the HDD 14. This generation is according to the order of printing determined by the print-sequence determining section 63. Furthermore, it is added with information, such as of a job ID, a terminal name and the number of double-sided prints generated by the double-sided printing information generating/adding section 62.

The opposite-surface printing data thus added with various pieces of information is sent to the printer 20 by the transmission/reception section 65.

At the printer 20 received the opposite-surface printing data, the data determining section 72 determines whether or not the job ID added to the opposite-surface printing data agrees with the job ID stored in the storage section 74. If not agreed, the data is retained in the data hold section 77. If agreed, the printing section 73 prints an image represented by the data to the recording paper relocated to the manual-feed tray 33.

Meanwhile, it can be expected that, after the recording paper is printed at one surface and relocated to the manual-feed tray 33, the state no printing is done continues because of a certain circumstance of the user. Conversely, despite relocated, there is a possible case the manual-feed double-sided printing is desired to cancel at that time.

In the latter case, when the user inputs a cancellation to the input section 67 of the PC 10, the information is sent to the printer 20 so that a paper discharging section 78 causes the recording paper (only in the number of double-sided prints) on the manual-feed tray 33 to exit directly through the paper exit 30. In the former case, although the manual-feed double-sided printing mode is automatically cancelled at a lapse of a certain constant time period, the opposite-surface printing data in the PC 10 remains left without being deleted. In this state, when the user inputs a desire of continuing the manual-feed double-sided printing to the input section 67 of the PC 10, a pseudo one-surface data generating section 70 transmits, as pseudo-one-side data, only information of job ID, terminal name and number of double-sided prints to the printer 20, thereby setting the printer 20 again in the manual-feed double-sided printing mode.

Thereafter, opposite-surface printing data is sent from the PC 10 to the printer 20. On condition of agreement in the job ID, an image the opposite-surface printing data represents is printed to the recording paper put in the manual-feed tray 33.

<Various Controls to Execute in PC 10>

The functions of the printing system 1 are explained in greater detail. Based on FIGS. 4 to 9, explanation is first made on the various controls to be executed at the PC 10. FIG. 4 is a flowchart representing a print-data transmission process to be executed at the PC 10 according to the illustrative aspect.

The print-data transmission process is started upon finally inputting a print instruction after clicking by a mouse (not shown) an on-screen print button of application 14 shown on a liquid-crystal display (one of the user interface 15), not shown, and completing the input to various setting items in a printer driver 43 setting screen displayed on the liquid-crystal display. Namely, it is started after inputting various setting items to the print-setting inputting section 61 (see FIG. 3) already noted. Incidentally, the setting items for user's input includes those items, e.g. whether to or not to perform a manual-feed double-sided printing, which tray is set to use, which paper size is set to use, and in what degree resolution is establishedp, as noted before.

When the FIG. 4 print-data transmission process is started, it is first determined whether or not there is a print setting using a manual-feed double-sided printing function (S110). This determination is made based on the content of the setting items the user has inputted on the setting screen. When the user failed to make a setting of a manual-feed double-sided printing on the printer-driver 43 setting screen, printing data is generated as it is (S120). The generated printing data is sent to the printer 20 (S130).

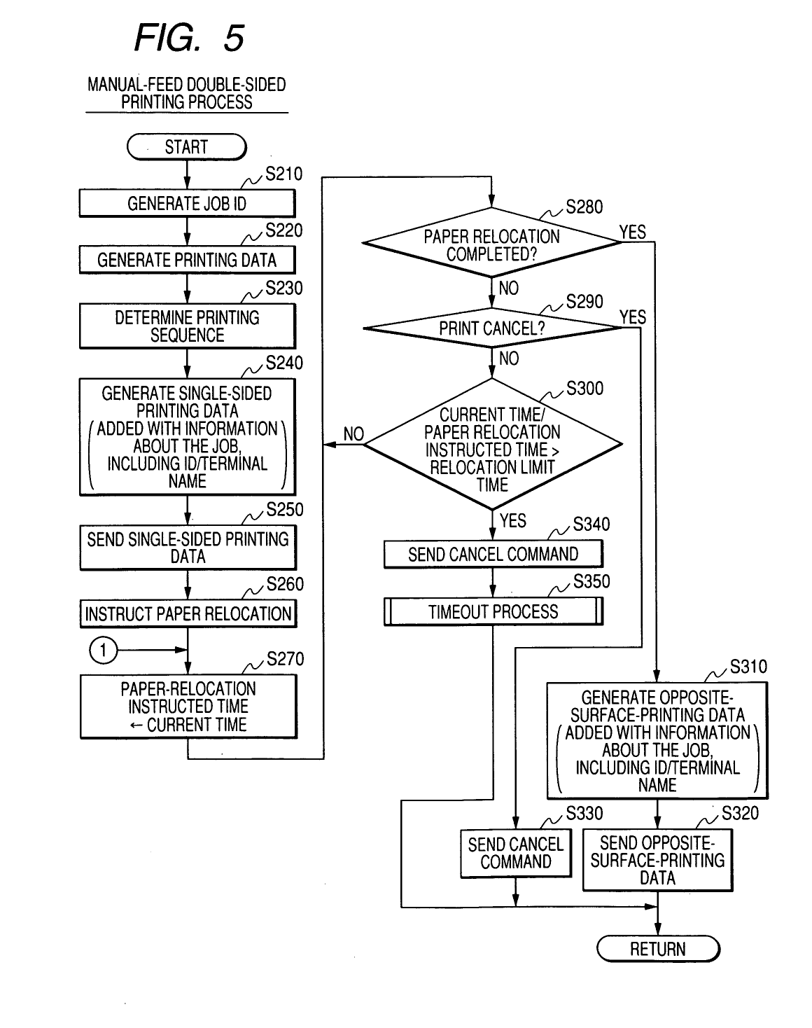

Meanwhile, when the user made a setting of manual-feed double-sided printing, the process at S110 is determined affirmative thus proceeding to S140, to perform a manual-feed double-sided printing process. The detail of the manual-feed double-sided printing process at S140 is as per the showing in FIG. 5.

As shown in FIG. 5, when a manual-feed double-sided printing process is started, first generated is a job ID, already noted, serving as an identifier of manual-feed double-sided printing data (S210). The job ID (corresponding to the identification ID in the invention) may be generated at random or determined from the current time or job number. It may be any one provided that unique to the job (manual-feed double-sided printing job). Incidentally, the job ID generated is stored in the RAM 13.

After generating the job ID, printing data is produced in an amount of all the pages (S220). The printing data generated here is in an intermediate file form, already noted, which, after generated, is spooled in the HDD 14 by the print spooler 52.

After printing data is produced in an amount of all the pages, print sequence is determined depending upon the number of pages to print, paper feeding and discharge ways on the printer 20 and so on. For example, paper feed is made starting at the uppermost paper of the recording papers stacked on the paper tray, to print an image to the upper surface of the recording paper, as in the printer 20 according to the illustrative aspect. In a structure that the recording paper is discharged in a state the image-printed surface faces down from the paper exit 30, where to print an image in an amount of 8 pages, the following sequence is taken. Namely, printing is first made to respective one surfaces of four recording papers (which serves as “one surface”) in the order of from 8-th page, 6-th page, 4-th page and 2-nd page. Those are relocated as they are (in a state the image on the 8-th page is in a bottom position) to the paper tray 33, to make a printing to the opposite surfaces (which serves as “opposite surface”) in the order of from 1-st page, 3-rd page, 5-th page and 7-th page. The printing order is determined by the FIG. 3 print-sequence determining section 63.

After determined the printing order, single-sided printing data is generated (S240). This is produced by extracting page data out of the printing data (under spool) produced at S220 in the order determined at S230 and then rearranging it. Furthermore, to the single-sided printing data is added information indicative of a job ID generated at S210, a PC 10 terminal name (corresponding to generation-source information in the invention) and manual-feed double-sided printing data, information designating a paper size and paper tray and various pieces of information about the relevant job, e.g. recording paper sheets for double-sided printing. The generated single-sided printing data is sent to the printer 20 (S250).

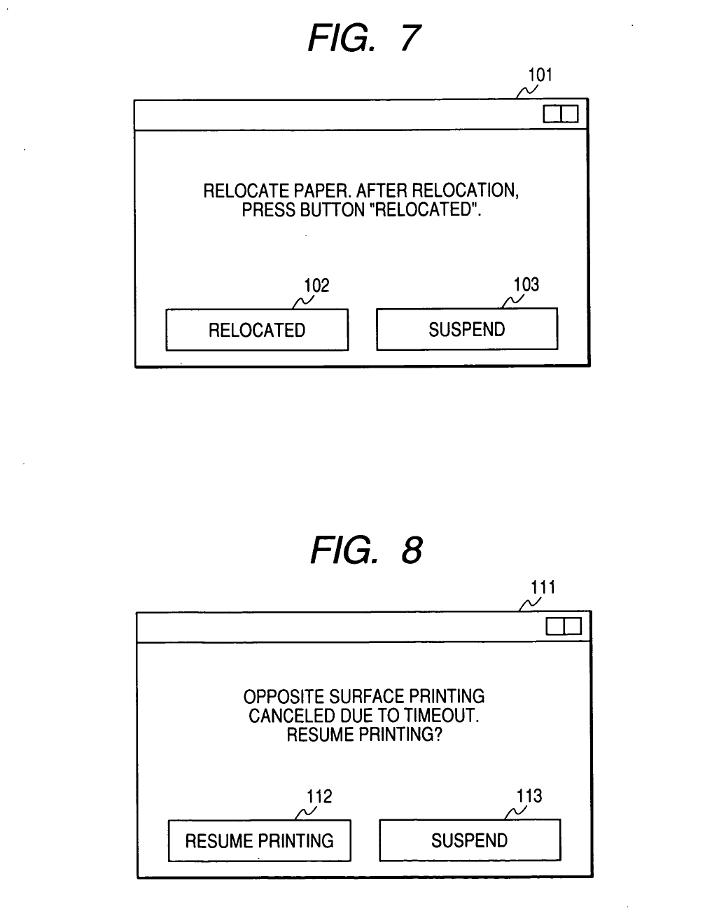

After sending the single-sided printing data, the user is instructed to relocate the recording paper (S260). Namely, at the printer 20, instruction is made to relocate the recording paper, printed an image at one surface, to the manual-feed paper tray 33 depending upon the single-sided printing data. It can be considered as a concrete instruction way to display a message 101 shown, say, in FIG. 7 on the liquid-crystal display of the PC 10. After instructing to relocate the recording paper, the current time is stored as paper-relocation instructed time (S270). The paper-relocation instructed time is also stored in the RAM 13.

Then, it is determined whether or not the relocation of the recording paper (again putting in the manual feed tray 33) is completed (S280). When the relocation complete button 102 in the FIG. 7 message 101 is clicked at this time by user's operation, determination is made as relocation completed (S280: Yes). While the “Relocated” button 102 is not clicked, the process proceeds to S290 where it is determined whether or not there is an instruction of print cancel.

When a “Suspend” button 103 in the FIG. 7 message 101 is clicked at this time by user's operation, it is determined that the manual-feed double-sided printing is cancelled (S290: Yes). By sending a cancel command to the printer 20 (S330), the manual-feed double-sided printing is terminated. While the “Suspend” button 103 is not yet clicked, the process proceeds to S300.

At S300, calculated is a difference between the paper-relocation instructed time stored at S270 and the current time. When a relocation limit time set previously is exceeded, a cancel command is sent to the printer 20 (S340). The relocation limit time ( which serves as “wait time”) may be a prefixed time, e.g. 1 minute, or changed freely in its setting by the user. When the relocation limit time is not exceeded, the process returns to S280.

After sending a cancel command at S340 due to exceeded relocation limit time, a timeout process is performed (S350). Namely, when the “Suspend” button 103 is clicked by a user's operation to cope with a continuing state of not relocation of a recording paper printed at one surface thereof, a cancel command is sent on the assumption the user apparently intends to cancel the manual-feed double-sided printing thereby deleting completely the job data related to the manual-feed double-sided printing. Meanwhile, when the relocation limit time is exceeded although not clicked the “Suspend” button 103 by the user, user's intention is not known. First of all, a cancel command is sent to the printer 20. However, the process proceeds to a timeout process (S350) while keeping the data/information related to the relevant manual-feed double-sided printing, such as opposite-surface printing data and job ID.

When the relocation is determined completed and hence the process moved from S280 to S310, opposite-surface printing data is generated corresponding to the image to print on the opposite surface of the recording paper. Furthermore, to the opposite-surface printing data is added information of the job ID generated at S210, PC 10 terminal name, and the number of recording papers for double-sided printing. The generated opposite-surface printing data is sent to the printer 20 (S320).

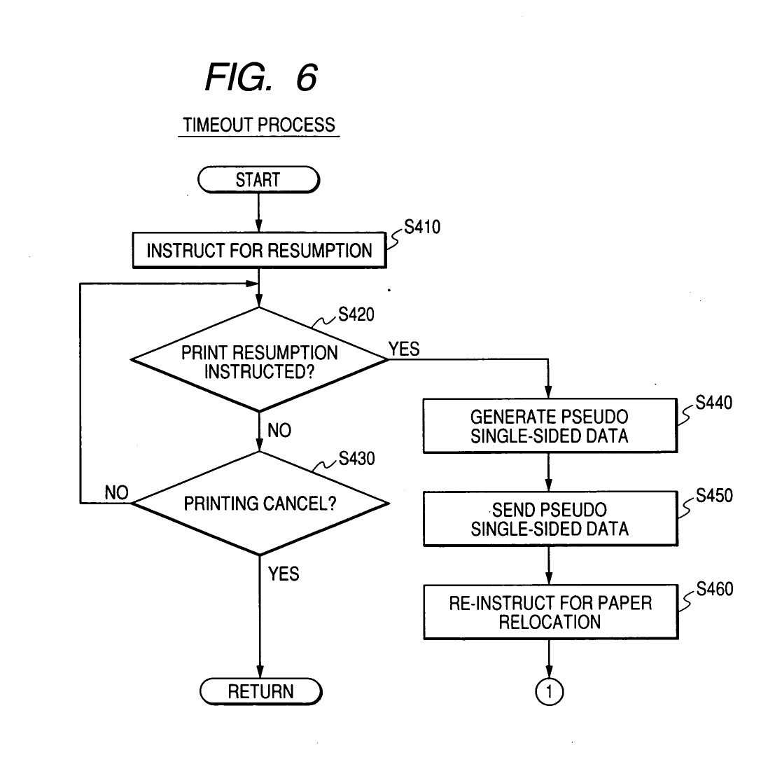

Based on FIG. 6, explanation is made on the timeout process (S350) to be execute when the relocation limit time is passed. In the timeout process, the user is first inquired whether or not to resume a printing as to the opposite-surface printing data suspended (S410). It can be considered as a concrete instruction way to display a message 111 as shown in FIG. 8 on the liquid-crystal display of the PC 10.

When the user clicked the “Suspend” button 113 in the message 111 thereby indicating the intention not to resume a printing (S430: Yes), the timeout is terminated as it is. This terminates the manual-feed double-sided printing, thus deleting the data related to the relevant manual-feed double-sided printing stored so far.

Meanwhile, when the user clicked the “Resume Print” button 112 thereby instructing to resume a printing (S420: Yes), pseudo single-sided data is generated (S440). The pseudo single-sided data generated here is data to set the printer again in the manual-feed double-sided mode. Specifically, it is constituted by the job ID generated at S210, the PC 10 terminal name, and the number of recording papers for double-sided printing, wherein there is not included printing data as it is representative of an image.

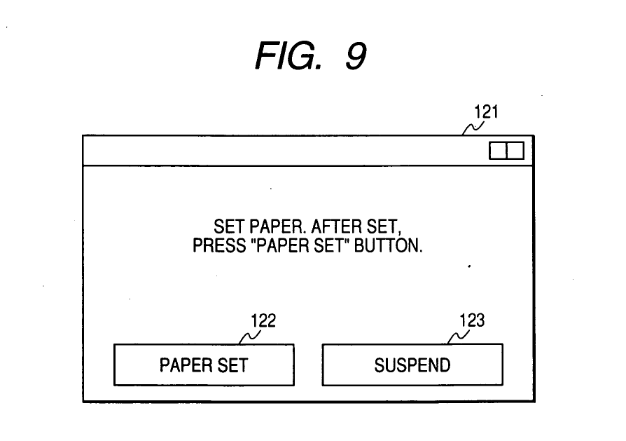

When the generated pseudo single-sided data is sent to the printer 20 (S450), reinstruction is made to relocate the paper (S460). It can be considered, as a paper-relocation concrete way, to display a message 121 shown in FIG. 9 on the liquid-crystal display of the PC 10. Note that the FIG. 9 message 121 is substantially identical to the FIG. 7 message 101.

After the paper relocating reinstruction at S460, the timeout process is terminated and the process moves to S270 in a manual-feed double-sided printing (FIG. 5). When “Paper Set” button 122 is clicked, the process proceeds from S280 to S310. When the “Suspend” button 123 is clicked, the process proceeds from S290 to S330.

<Various Controls to Execute at the Printer 20>

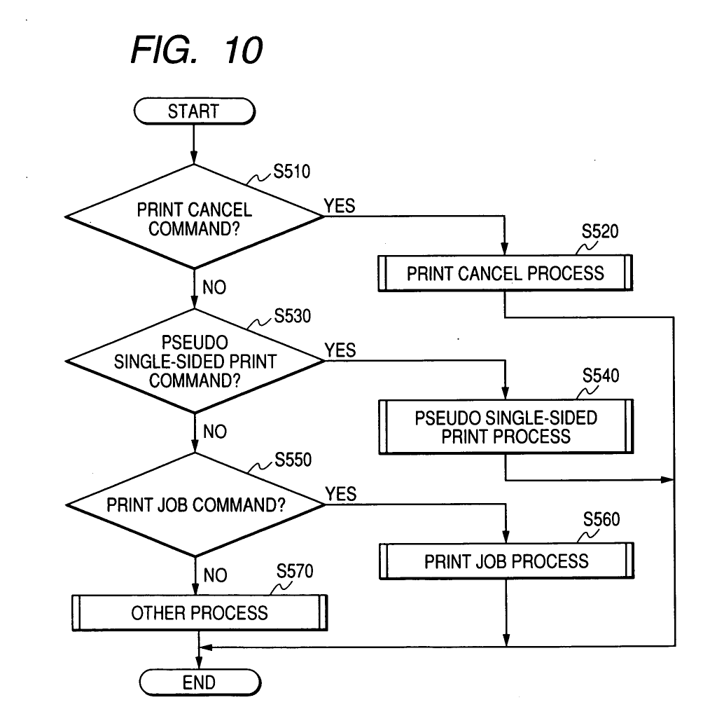

Based on FIGS. 10 to 15, explanation is now made on various controls to be executed at the printer 20. FIG. 10 is a flowchart showing a data-receiving process to be executed at the printer in the embodiment.

The printer 20 in this embodiment executes a data-receiving process of FIG. 10 each time data is received by the LAN interface 27. When this process is started, it is first determined whether or not the received data is a print-cancel command (S510). The print-cancel command is sent at S330 or S340 in the FIG. 5 manual-feed double-sided printing, as already noted.

When receiving a print cancel, a print-cancel process is executed (S520). When not a print-cancel command, determination is made as to whether or not it is a pseudo single-sided print command, i.e. whether or not it is pseudo single-sided data sent at S450 in the FIG. 6 timeout process (S530). If it is a pseudo single-sided print command, the process proceeds to a pseudo single-sided print process (S540).

Furthermore, when not a pseudo single-sided print command, determination is made as to whether or not a print-job command, i.e. whether or not it is printing data sent at S130 in the FIG. 4 print-data transmission process or printing data sent at S250, S320 in the FIG. 5 manual-feed double-sided print process (S550). When a print-job command, a print-job process is performed (S560). When not a print-job command, performed is another process, i.e. a process in accordance with the data received (S570). Note that the determination process at S510, S530 and S550 can be performed, say, based on the flag included in the received data.

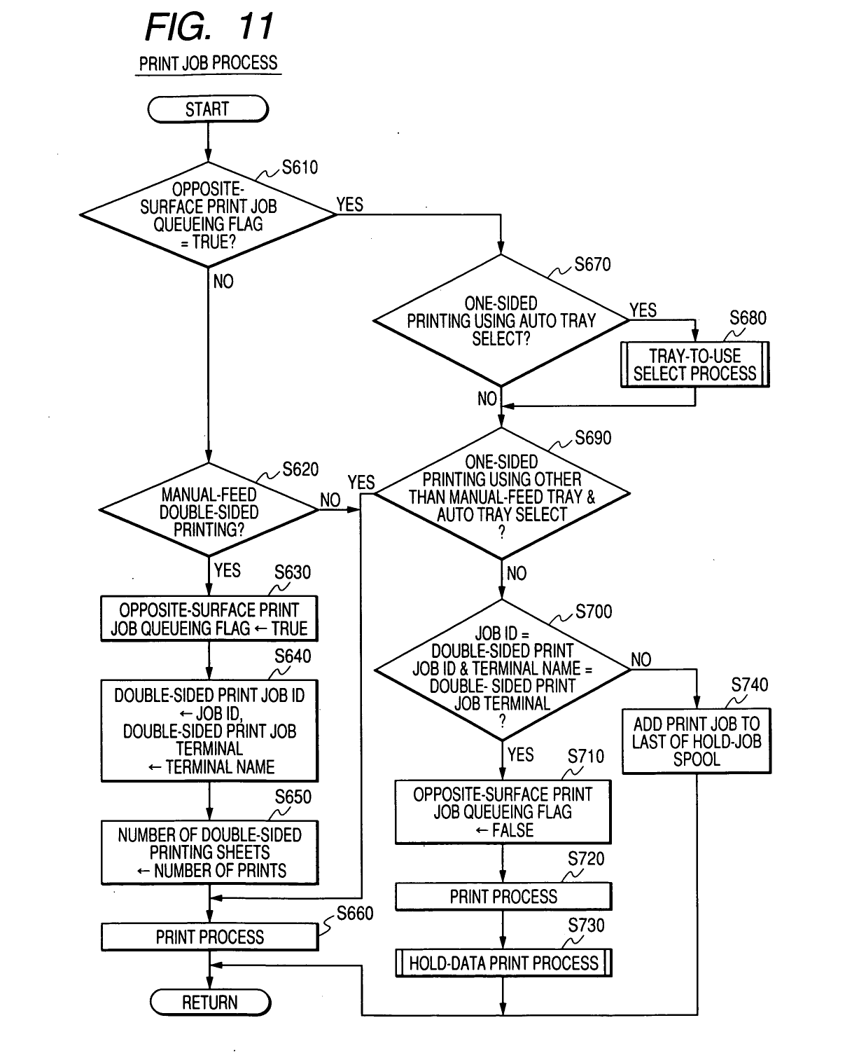

Based on FIG. 11, explanation is made on the print-job process of S560. When printing data is received and the process moves into the main process, it is first determined whether or not an opposite-surface print-job gueueing flag is “true”, i.e. whether or not the printer 20 is in a setting of manual-feed double printing mode (S610). When the opposite-surface print-job gueueing flag is “true”, the process proceeds to S670 while, when “false”, the process proceeds to S620. Note that the opposite-surface print-job gueueing flag has an initial value “false”.

When determined not “true” at S610, i.e. when the printer 20 is not yet in a setting of manual-feed double-sided printing, it is determined whether or not the received printing data corresponds to a manual-feed double-sided printing (S620). This determination is made based on whether there is added information indicative of printing data corresponding to a manual-feed double-sided printing. When there is no addition, determination is made as the usual printing data, thus performing a print process as it is (S660). Incidentally, the determination at S620 may be depending upon whether or not there is an addition of a job ID corresponding to a manual-feed double-sided printing.

When the received printing data corresponds to a manual-feed double-sided printing, the process proceeds to S630 where the opposite-surface print-job gueueing flag is set as “true”. This means a reception of single-sided printing data of manual-feed double-sided printing data. Namely, by receiving single-sided printing data, the printer 20 is set in a manual-feed double-sided print mode.

Subsequently, stored are the job ID included in the job data (i.e. job ID added to single-sided printing data) as “double-sided print-job ID” and the terminal name as “double-sided print-job terminal” (S640). Furthermore, stored as “number of double-sided printing sheets” is the number of recording papers for double-sided printing included in the job data (S650). Those are stored in the RAM 23 provided in the printer 20. Printing is performed as to the printing data (single-sided printing data) received (S660).

When the opposite-surface print-job gueueing flag is “true” in the S610 determination process, i.e. when the printer 20 is set in a manual-feed double-sided print mode wherein it is in a state waiting for opposite-surface printing data, it is determined whether or not the paper tray setting is in an “auto tray select” mode for the printing data (job data) received (S670).

If not in “auto tray select” (S670: No), it is further determined whether or not a single-sided printing with using a setting of other than “manual-feed tray” and “auto tray select” (S690). Even in the state waiting for opposite-surface printing data, printing is possible to perform, without limitation, as to a single-sided print job using another than the manual-feed tray 33 or a job in a setting of other than “auto tray select” (i.e. where the user designated any one of the first and second paper trays 31, 32). In this case, printing is performed immediately (S660).

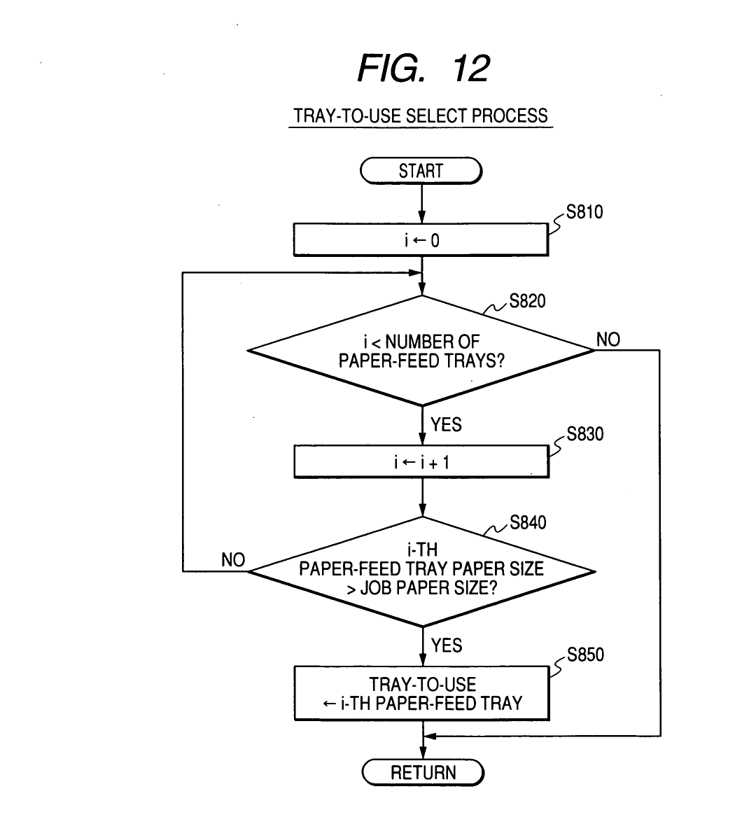

In the case of “auto tray select” setting (S670: Yes), a tray-to-use select process is performed (S680). The transition to S680 is in a status that the relevant job in a manual-feed double-sided printing is waiting for an opposite-surface printing after printed to one surface of recording paper wherein another job using “auto tray select” comes. The tray-to-use select process (S680) for a job set with “auto tray select” is detailed as per the showing in FIG. 12.

When the tray-to-use select process shown in FIG. 12 is started, initialization is made by substituting “0” for “i” (S810). Then, the value “i” is compared with the number of paper trays (excepting the manual-feed tray 33) (S820). In this embodiment, because the number of paper trays is two except the manual-feed tray 33, it is determined whether or not “i” is smaller than 2.

Because “i”=0 results where the S820 determination is first made, determination is affirmative at S820 and hence the process proceeds to S830. Then, “i” is added by 1 at S830. At the next S840, comparison is made between the size of the paper in the i-th paper tray and the size of the paper represented by the paper-size-designate information added to the received job printing data.

In the case of the printer 20 of the illustrative aspect, the paper in the first paper tray 31 is of B5 size. Accordingly, if the job received should be designated for paper size A4, determination is negative at S840 and hence the process returns to S820. Then, comparison is again performed with “i”(=2) (S820), resulting in an affirmative determination again. Hence, “i” is added by 1 at S820 and the process enters the process of S840 again.

In this step, comparison is made between the paper size of the second paper tray 32 and the paper size of the job. In this case, the both agrees as A4 size, and the process proceeds to S850 where the i-th paper tray (the second paper tray in this example) is selected as a paper tray to use, thus ending the tray-to-use select process. Meanwhile, in the case that the job is designated a size not provided on the printer 20, e.g. A4 or B4 size, determination is made negative at S820. Thus, the process is ended without selecting any tray to use.

When the FIG. 12 tray-to-use select process terminates, the process proceeds to a determination of S690 in the FIG. 11 print-job process. At this time, When any of the paper trays is selected in the FIG. 12 tray-to-use select process, determination is affirmative at S690, to perform a printing using the selected paper tray (S660) However, when there is not selected a tray-to-use in the FIG. 12 tray-to-use select process, the setting of tray-to-use remains as “auto tray select”. Hence, the process proceeds from S700 to S740 where the data of the job is held (stored) in the last of a hold job spool. The hold job spool refers to a predetermined domain in the RAM 23 provided in the printer 20.

In the case it is single-sided printing data set with the other than “manual-feed tray” or “auto tray select”, i.e. in the case not selected a proper paper tray in the S680 tray-to-use select process despite there is a setting of usual single-sided printing, manual-feed double-sided printing or “auto tray select” having a designation of manual-feed tray 33, determination is made as to whether or not the job ID and terminal name added to the printing data each agrees with the “double-sided print job ID” and “double-sided print job terminal” stored in the RAM 23 (S700).

The S700 determination is made affirmative when received opposite-surface printing data corresponding to the single-sided printing data printing already done. In this case, because the job IDs and terminal names added to the both of printing data are each in agreement, the process proceeds to S710 where the opposite-surface print gueueing flag is rendered “false”, thus making a printing as to the image the relevant opposite-surface printing data represents (S720). Thereafter, printing is performed as to the printing data held in the RAM 23 while the opposite-surface print job gueueing flag is “true”.

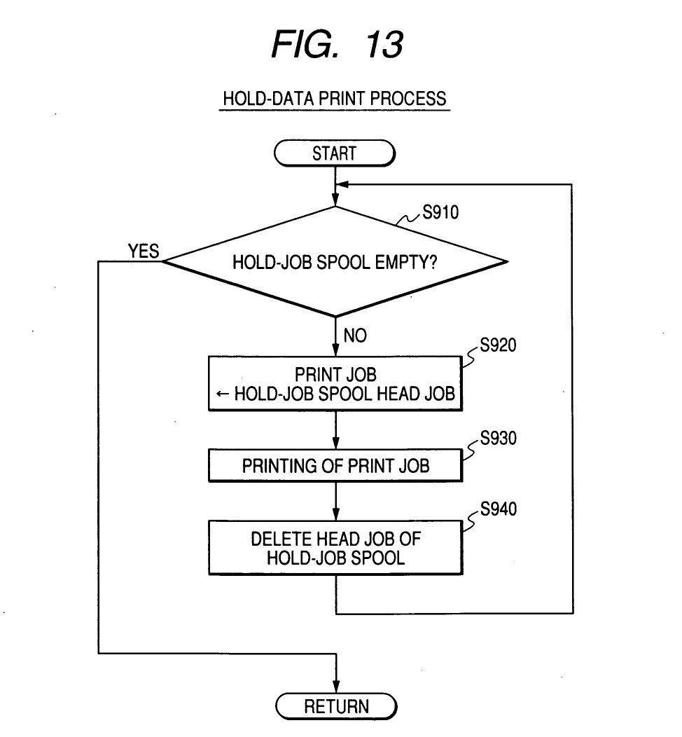

FIG. 13 shows the detail of the hold-data printing process. When the hold-data printing process is started, it is first determined whether or not the hold job spool in the RAM 23 is empty (free of printing data) (S910). When not empty, i.e. when hold data is stored, the job at the head of the hold job spool is rendered as a printing job (S920), to perform a printing of the printing job (S930). After printing, the head job is deleted from the hold job spool (S940), and the process again returns to S910, to continue the process. Namely, the loop of from S910 to S940 is repeated until the hold job spool becomes empty. When the hold data becomes absent finally, determination is affirmative at S910 thus ending the hold-data printing process.

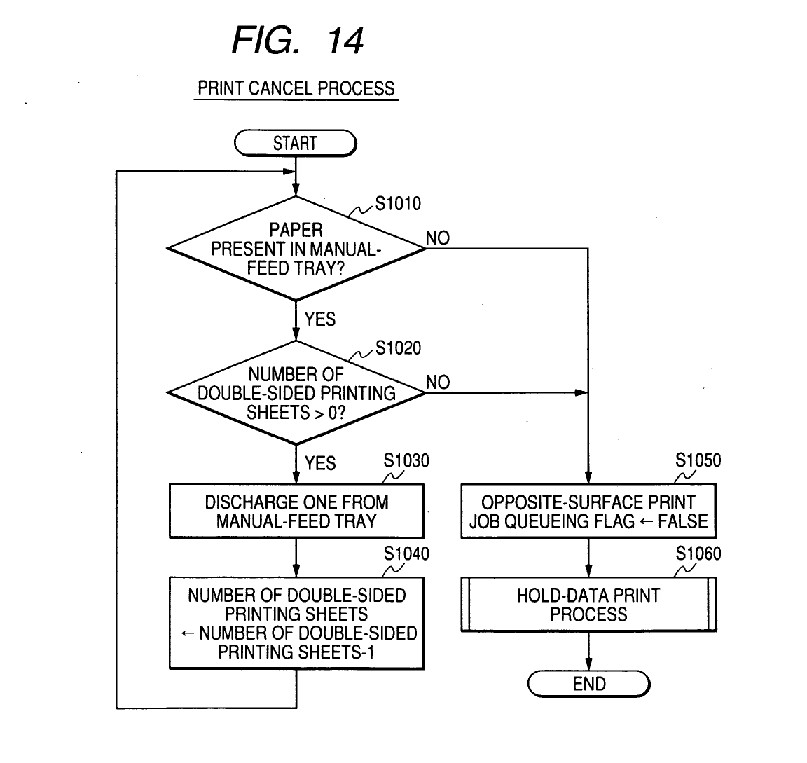

Based on FIG. 14, explanation is now made on the detail of the print-cancel process at S520 in the FIG. 10 data reception process. When the process is started by receiving a cancel command from the PC 10, it is first determined whether or not a paper is put in the manual-feed tray 33 (S1010). This determination is made by a detection using a paper sensor, not shown. Incidentally, the determination may be made by confirming whether or not successful by actually feeding the recording paper. It can employ every techniques for determining the presence or absence of a paper on the manual-feed tray 33.

When determined there is a recording paper on the manual-feed tray 33, determination is made as to whether or not the number of double-sided printing sheets is greater than 0 (S1020). When greater than 0, one recording paper only is discharged from the manual-feed tray 33 (S1030). At the subsequent S1040, the number of double-sided printing sheets is subtracted one, and the process returns to S1010 and the subsequent.

When the recording papers becomes absent in the manual-feed tray 33 or when the number of double-sided printing sheets becomes 0, the process proceeds to S1050 where the opposite-surface print job gueuing flag is rendered “false”, to make a printing of hold data (S1060). The hold-data printing is quite similar to that explained in FIG. 13.

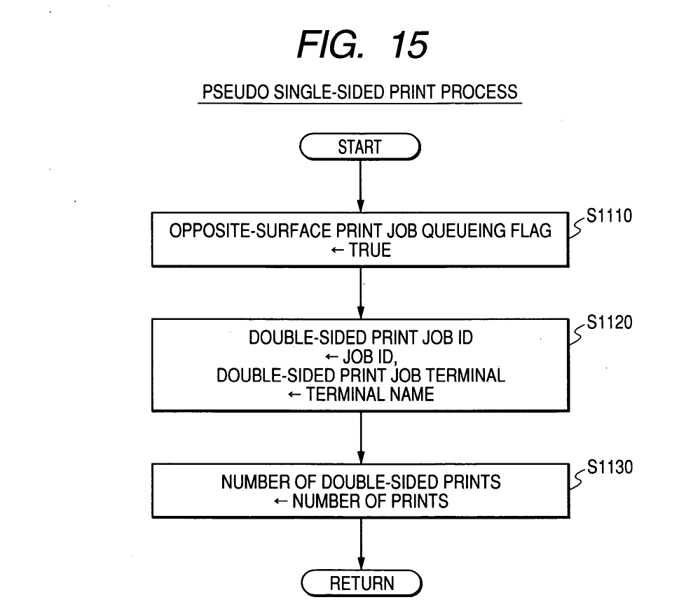

The pseudo single-sided printing at S540 in the FIG. 10 data reception process is detailed as per the showing in FIG. 15. This process is quite similar to the process of S630-S650 in the FIG. 11 print-job process. Namely, when this process is started by receiving a pseudo single-sided data from the PC 10, the opposite-surface print job gueueing flag is first set as “true” (S1110). Subsequently, the job ID included as pseudo single-sided data is stored as “double-sided print job ID” and the terminal name as “double-sided print job terminal” (S1120). Furthermore, the number of recording papers for double-sided printing included as pseudo single-sided data is stored as “the number of double-sided printing sheets” (S1130).

Namely, such pseudo single-sided printing is merely to set a flag or store a job ID, etc., i.e. not to print an image to a recording paper. By thus making a pseudo single-sided printing, the opposite-surface job gueueing flag can be set as “true” without the need to perform an actual printing. This makes it possible to prevent other images from printing to the recording paper relocated in the manual-feed tray 33.

According to the printing system 1 in the illustrative aspect explained so far, after effecting a printing to one surface of a recording paper in a manual-feed double-sided printing, no printing is made to the recording paper put in the manual-feed tray 33, as to those excepting the opposite-surface printing data added with the same job ID and terminal name. This can prevent other images not intended from being printed to the opposite surface of a recording paper, thus positively printing a desired image to the both surface of the recording paper.

Meanwhile, by prompting the user to make an input through displaying a message 101 (FIG. 7), a message (FIG. 8) or a message (FIG. 9) on the liquid-crystal display, the transmission timing is determined of opposite-surface printing data or the intention for a post-timeout reprint is confirmed. This can provide a printing system convenient for the user to use.

Furthermore, when there arises printing data the manual-feed tray 33 is selected while the opposite-surface print job gueuing flag assumes “true”, the relevant data is stored in the RAM 23 instead of being damped away so that printing can be made as to the stored printing data after the flag turned into “false”. This can eliminate the troublesomeness that the printing data not printed during “true” in the flag is generated later.

Meanwhile, as to the printing data stored in the RAM 23 (hold job), printing is made after double-sided printing completed to turn the flag “true”. This can positively print each of printing data generated.

After a printing to the one surface, when relocation limit time elapses without a relocate instruction, a cancel command is sent to render the flag “false”. This prevents the storage of a hold job to the RAM 23. This can suppress the increase of printing data to be stored as a hold job in the RAM 23.

Meanwhile, in the case a cancel command is sent in a state not printed an image represented by the opposite-surface printing data, the recording papers in the manual-feed tray 33 are discharged the number of recording papers to make a double-sided printing in addition to merely return of the flag to “false”. This accordingly can prevent a recording paper in a state printed as to single-sided printing data from being left staying on the manual-feed tray 33, thus preventing an unintended image from being printed to the opposite surface of the recording paper.

Revealed here is the corresponding relationship of between processes of the illustrative aspect and the constituent elements. In the FIG. 5 manual-feed double-sided printing, the steps S240 and S310 each serving as the processing to be executed by “a print-data generating unit and “an identification-information adding unit”, the steps S250 and S320 each serving as the processing to be executed by “a transmitting unit”, the steps S270 and S300 each serving as the processing to be executed by “a measuring unit”, the step S280 serves as the processing to be executed by “a relocation detecting unit”, the step S340 corresponds to the processing to be executed by “a time-based print-cancel output unit”, and the step S300 corresponds to the processing to be executed by “a self-controlled print-cancel output unit”.

Meanwhile, in the FIG. 11 print job, the steps S630 serves as the processing to be executed by “a double-sided print mode setting unit”, the step S660 corresponds to the processing to be executed by “a first printing unit”, the step S700 serves as the processing to be executed by “a identification-information determining unit”, the step S720 serves as the processing to be executed by “a second printing unit”, the step S730 serves as the processing to be executed by “a third printing unit”, and the step S740 serves as the processing to be executed by “a hold-data storage unit”.

Furthermore, in the FIG. 14 print-cancel process, the steps S1010-S1040 each serve as the processing to be executed by “a paper discharging unit”, the step S1050 serves as the processing to be executed by “a double-sided-print-mode canceling unit”, and the step S1060 serves as the processing to be executed by “a fourth printing unit”.

Furthermore, in the FIG. 15 pseudo single-sided printing, the step S1110 corresponds to the processing to be executed by the mode resetting unit.

The “Suspend” button 103 in the message 101 shown in FIG. 7 corresponds to “a suspend-setting input unit”, and the “Resume Print” button 112 and “Suspend” button 113 in the message shown in FIG. 8 corresponds to “a continuation-instruction input unit”.

<Modification>

The invention is not limited to the illustrative aspects but can take various forms provided that belonged to the technical scope of the invention.

For example, in the illustrative aspects, on condition that the job ID and terminal name added to the opposite-surface printing data agrees with the job ID and terminal name added to the one-surface printing data, the image represented by the opposite-surface printing data is printed to the recording paper in the manual-feed tray 33. It is mere one example to add the same job ID and terminal name to the both of printing data in this manner, e.g. identification information, representative of a relationship of between both of printing data not identical, may be added to one-surface printing data and opposite-surface printing data.

In this case, when printing data as to the manual-feed tray 33 is received after printing an image represented by one-surface printing data, it is determined whether or not the identification information added to the printing data is related to the identification information added to the one-surface printing data. When related, printing may be made to the recording paper in the manual-feed tray 33 on an assumption the relevant printing data is normal opposite-surface printing data.

Meanwhile, the determination at S280 in the FIG. 5 manual-feed double-sided printing, i.e. determination as to whether or not completed the relocation of the recording paper, was performed depending upon whether or not clicked the “Relocated” button 102 in the FIG. 7 message 101. This however is mere one example. For example, a paper detecting sensor may be provided on the manual-feed tray 33 so that, when a paper relocation is detected by the sensor, the fact can be informed from the printer 20 to the PC 10. Alternatively, after relocating the recording paper to the manual-feed tray 33, the fact of relocation may be informed to the PC 10 by user's operation of the printer 20.

Furthermore, in the FIG. 12 tray-to-use select process, although the tray-to-use is selected by comparing paper size, it is not limited to paper size. For example, selection may be by comparing the media type (thick paper, thin paper, OHP sheets, or the like), or by comparing between a plurality of conditions.

Furthermore, although the illustrative-aspects exemplified the color-laser printer as a printer 20 constituting the printing system 1, such a laser-beam printer is not limitative. Provided that having a manual-feed double-sided function is provided, application is possible to various types of printers, e.g. a printer of a inkjet recording scheme.

The printer 20 may not have only a printer function (image forming function). For example, where it is arranged as a complex machine having a plurality of functions, including the function of scanner, copier and facsimile, in addition to the printer function.

Without limited to the printing systems that a plurality of PCs and printers are connected together through a network, the invention is applicable to a system where PCs and printers are connected in a one-to-one relationship or to one apparatus where PC function (printing data generation) and image printing (printer function) are integrated together.

According to the illustrative aspects, the printing system thus arranged, when to perform a double-sided printing for printing an image to the both surfaces of a recording medium, generated are first printing data corresponding to one surface and second printing data corresponding to the other surface, to add identification information representative of a relationship to each of the printing data. After at least the recording medium is relocated to the paper feeding unit after a printing of an image of the first printing data to one surface of the recording medium, as for printing data related to the paper feeding unit is made a printing of an image as to printing data added with identification information related to the identification information added to the first printing data that printing is already done. For printing data related to the paper feeding unit but not added with related identification information, the second printing unit does not make a printing.

Consequently, when printing an image of the second printing data after printing an image of the first printing data, the identification information added to the second printing data is related to that added to the first printing data. Thus, the second printing unit performs a printing of an image represented by the second printing data to the recording medium put in the paper feeding unit.

According to the illustrative aspects, after made a printing to one surface of both-sided printing, no printing is made to a recording medium put in the paper feeding tray excepting the printing data added with related identification information, thus preventing the printing of an unintended image to the other surface. This makes it possible to positively print a desired image to the both surfaces of a recording medium.

Incidentally, the addition of identification information due to the identification-information adding unit includes not only, naturally, a later addition of identification information to first printing data and second printing data but also an incorporation in first printing data and second printing data.

It is possible to contemplate various concrete structures for the printing system. For example, according to the illustrative aspects, there can be considered a printing system arranged connecting an information processor and a printer together through a communication line and for printing, at the printer, to a recording medium an image represented by printing data sent from the information processor. Where the printing system is arranged like this, the information processor can be arranged having the print-data generating unit, the identification-information adding unit, and transmitting unit that sends the printing data to the printer, while the printer be arranged having the receiving unit that receives printing data sent at the transmitting unit, the first printing unit, the second printing unit and the identification-information determining unit.

The printing system arranged like this can obtains an effect similar to that of the printing system According to the illustrative aspects.

The printing system in the above arrangement can be configured having a relocation detecting unit that detects whether or not the recording medium is relocated to the paper feeding unit after the first printing unit made a printing to one surface of the recording medium.

The printing system arranged like this can positively detect a relocation of the recording medium to the paper feeding unit, thus making more positive the operation of the printing unit after the relocation (print execution as to the printing data added with related identification information).

Here, it is possible to contemplate variously identification information to be added by the identification-information adding unit. For example, it can be provided as information representing as printing data for printing of an image to both surfaces of a recording medium. However, in the case the information merely represents printing data for printing to both surfaces, when the print-data generating unit generates a plurality of kinds of print-data groups (comprising first printing data and second printing data), there is a possibility to add the same identification information to the both. If so, there is a fear that, after printing an image of first printing data in a certain printing data group to one surface of a recording medium, the printing data of another data group in certain print execution timing be printed to the other surface before printing an image of the second printing data of the same printing-data group to the other surface.

For this reason, the identification-information adding unit may be arranged to add a unique identification ID, as identification information, to both of first printing data and second printing data. Furthermore, it may be arranged to add unique generation-source information corresponding to the print-data generating unit generated the first and second printing data in addition to the identification ID.

By thus adding a unique identification ID as identification information, unique identification IDs are added respectively to the plurality of print-data groups exemplified, enabling a double-sided printing more positively. By adding generation-source information in addition to the identification ID, it is possible to realize a double-sided printing more positively.

According to the illustrative aspects,the printing system may comprise a hold-data storage unit that stores, as hold data, printing data that printing is not performed at the second printing unit because of not determined a fact there is added related identification information by the identification-information determining unit after the first printing unit made a printing to one surface of the recording medium.

According to the illustrative aspects,the printing data not determined added with related identification information by the identification-information determining unit is stored without deleted, thus eliminating the troublesomeness of generating such printing data later.

In this case, there may be provided a third printing unit that prints an image represented by the hold data stored by the hold-data storage after the second printing unit made a printing to the recording medium relocated to the paper feeding unit. By thus providing third printing unit, the hold data is not printed soon but will be printed in due course. Each of printing data generated can be printed positively.

According to the illustrative aspects, the printing system may comprise a double-sided printing mode setting unit that sets the printing system in a double-sided printing mode during a predetermined printing period of from a printing, by the first printing unit, of an image represented by the first printing data to a print completion, by the second printing unit, of an image represented by the second printing data. In this arrangement, the hold-data storage unit may store the hold data when set in the double-sided printing mode by the double-sided printing mode setting unit.

According to the illustrative aspects, the printing time period can be set desirably in the time period of from a start of printing of an image the first printing data represents by the first printing unit to an end of printing of an image the second printing data represents by the second printing unit. This may include at least a time period of from a relocation, to the paper feeding unit, of a recording medium printed, by the first printing unit, an image represented by the first printing data to a start of printing, by the second printing unit, of an image represented by the second printing data.

In case the printing time period (i.e. hold-data storage time period) is set like this, after the recording medium printed an image at one surface is relocated to the paper feeding unit, there is no possibility to make a printing of unintended other ones of printing data (printing data different in identification information) to the recording medium. This can positively obtain a desired double-sided printing result.

According to the illustrative aspects, a printing system comprises a measuring unit that measures a lapse time of from a print execution due to the first printing unit,a time-based print-cancel output unit that outputs a print cancel command when a lapse of a predetermined wait time is measured by the measuring unit in a state not made a printing to the recording medium by the second printing unit after a printing to one surface of the recording medium by the first printing unit, and a double-sided printing mode canceling unit that cancels the double-sided printing mode in a case the printing system is set in the double-sided printing mode when a print cancel command is outputted by the time-based print-cancel output unit.

According to the illustrative aspects, when a wait time elapses in a state no printing has been done as to the second printing data by the second printing unit after a printing made by the first printing unit, the double-sided printing mode is canceled. Due to this, hold-data storage is not made in the hold-data storage unit. This can suppress the printing data, to be stored as hold data, from increasing.

Meanwhile, where there is provided a double-sided printing mode releasing unit in this manner, a continuation-instruction input unit allows an operator to input an instruction of whether or not to perform a printing of an image represented by the second printing data after canceling the double-sided printing mode by the double-sided print mode canceling unit. A mode resetting unit sets the printing system again in the double-sided printing mode when an instruction for printing is inputted by the continuation-instruction input unit.

According to the printing system arranged like this, even when the double-sided printing mode is canceled while the operator (user or the like of the printing system) is kept not allowed to relocate the recording medium by a certain circumstance, setting is easy again to a double-sided printing mode by the continuation-instruction input unit. The double-sided printing suspended can be resumed without incurring a great delay.

Meanwhile, it can be expected that there is caused a case to desirably stop the printing to the other surface (i.e. case to desirably stop the double-sided printing) because of a certain circumstance despite printing is completed to one surface of the recording medium.

Consequently, the printing system is configured by cancel-setting input unit that allows the operator to input a setting to suspend a printing of an image represented by the second printing data due to the second printing unit after performing a printing due to the first printing unit, a self-controlled print-cancel-command output unit that output a print cancel command when the cancel setting is inputted by the cancel-setting input unit, and a double-sided print mode canceling unit that cancels a double-sided print mode in a case the printing system is set in a double-sided print mode when a print cancel command is outputted by the print-cancel-command output unit.

According to the illustrative aspects, the user is allowed to desirably stop the double-sided printing thereby ceasing the storage of hold data. Hence, it is possible to provide a printing system more convenient to use.

In the meanwhile, in case the recording medium printed with an image the first printing data represents at one surface is kept relocated on the paper feeding unit even after canceling the double-sided printing mode due to outputting a print-cancel command, there is a fear to print unintended other images to the other surface of the recording medium.

According to the illustrative aspects, a paper discharge unit discharges, from the paper feed unit, recording mediums in a same number as recording mediums printed an image represented by the first printing data in the first printing unit unintended other images can be prevented from being printed to the other surface.

According to the illustrative aspects, a fourth printing unit performs a printing of an image represented by the hold data stored by the hold-data storage unit after a discharge due to the paper discharging unit, it is possible to positively print as to hold data.

According to a storage medium readable by a computer, the above-illustrative aspect's printing system can be configured, and effect of the printing system can be obtained.

Incidentally, the storage medium according to the illustrative aspects, comprising a progression of sequential orders suited for computer processing, is supplied to the user through a recording medium, e.g. an FD, a CD-ROM or a memory card, or a communication line network, such as the Internet. Such a program can be supplied to the user, in the form preinstalled on a hard disk or memory.

What is claimed is:

1. A printing system comprising:
a print-data generating unit that generates first printing data corresponding to a first image to print to one surface of recording medium and second printing data corresponding to a second image to print to the other surface of the recording medium;
an identification-information adding unit that adds, to the first and second printing data generated by the print-data generating unit, identification information representing a relationship between the first printing data and the second printing data;
a first printing unit that prints the first image represented by the first printing data to the one surface of the recording medium;
a second printing unit that prints an image to a recording medium put on a paper feeding unit; and
an identification-information determining unit that determines, when a print is requested based on printing, data for printing to a recording medium put on the paper feeding unit after printing the first image represented by the first printing data to the one surface of the recording medium by the first printing unit, whether or not identification information related to the identification information added to the first printing data is added to the printing data; and
the second printing unit performs a printing as to the printing data for printing to the recording medium put on the paper feeding unit after printing the first image to the one surface of the recording medium by the first printing unit, when the identification-information determining unit determines that the identification information added first printing data is added to the printing data.

2. The printing system according to claim 1, wherein the printing system is configured so as to mutually connect an information processor and a printer through a communication line,
wherein the printing is configured so as to print, at the printer, to a recording medium an image represented by printing data transmitted from the information processor,
wherein the information processor comprises:
the print-data generating unit;
the identification-information adding unit; and
a transmitting unit that transmits the printing data to the printer, and
wherein the printer comprises:
a receiving unit that receives the printing data transmitted by the transmitting unit;
the first printing unit;
the second printing unit; and
the identification-information determining unit.

3. The printing system according to claim 1, further comprising:
a relocation detecting unit that detects, after the first printing unit made a printing to the one surface of the recording medium, whether or not the recording medium is relocated to the paper feeding unit.

4. The printing system according to claim 1, wherein the identification-information adding unit adds, as the identification information, a unique identification ID to both the first printing data and the second printing data.

5. The printing system according to claim 4, wherein the identification-information adding unit adds, as the identification information, unique generation-source information corresponding to the print-data generating unit generated the first and second printing data, in addition to the identification ID.

6. The printing system according to claim 1, further comprising:
a hold-data storage unit that stores, as hold data, printing data that printing is not performed at the second printing unit because of not determined a fact there is added related identification information by the identification-information determining unit after the first printing unit made a printing to the one surface of the recording medium.

7. The printing system according to claim 6, further comprising:
a third printing unit that prints an image represented by the hold data stored in the hold-data storage unit after the second printing unit performed a printing to the recording medium relocated to the paper feeding unit.

8. The printing system according to claim 6, further comprising:
a double-sided printing mode setting unit that sets the printing system in a double-sided printing mode during a predetermined printing period of from a printing, by the first printing unit, of the first image represented by the first printing data to a print completion, by the second printing unit, of the second image represented by the second printing data,
the hold-data storage unit storing the hold data when set in the double-sided printing mode by the double-sided printing mode setting unit.

9. The printing system according to claim 8, wherein
the printing period includes at least a time period of from a relocation, to the paper feeding unit, of a recording medium printed, by the first printing unit, the first image represented by the first printing data to a start of printing, by the second printing unit, of the second image represented by the second printing data.

10. The printing system of claim 8, further comprising:
a measuring unit that measures a lapse time of from a print execution due to the first printing unit,
a time-based print-cancel output unit that outputs a print cancel command when a lapse of a predetermined wait time is measured by the measuring unit in a state not made a printing to the recording medium by the second printing unit after a printing to one surface of the recording medium by the first printing unit, and
a double-sided printing mode canceling unit that cancels the double-sided printing mode in case that the printing system is set in the double-sided printing mode when a print cancel command is outputted by the time-based print-cancel output unit.

11. The printing system of claim 10, further comprising:
a continuation-instruction input unit that allows an operator to input an instruction of whether or not to perform a printing of the second image represented by the second printing data after canceling the double-sided printing mode by the double-sided print mode canceling unit, and
a mode resetting unit that sets the printing system again in the double-sided printing mode when an instruction for printing is inputted by the continuation-instruction input unit.

12. The printing system according to claim 8, comprising:
a cancel-setting input unit that allows an operator to input a setting to suspend a printing of the second image represented by the second printing data due to the second printing unit after performing a printing due to the first printing unit,
a self-controlled print-cancel-command output unit that output a print cancel command when the cancel setting is inputted by the cancel-setting input unit, and
a double-sided print mode canceling unit that cancels a double-sided print mode in a case the printing system is set in a double-sided print mode when a print cancel command is outputted by the print-cancel-command output unit.

13. The printing system according to claim 10, further comprising:
a paper discharge unit that discharges, from the paper feed unit, recording mediums in a same number as recording mediums printed an image represented by the first printing data in the first printing unit.

14. The printing system of claim 13, further comprising:
a fourth printing unit that performs a printing of an image represented by the hold data stored by the hold-data storage unit after a discharge due to the paper discharging unit.

15. A printer, comprising:
a print-data generating unit that generates first printing data corresponding to a first image to print to one surface of recording medium and second printing data corresponding to a second image to print to the other surface of the recording medium;
an identification-information adding unit that adds, to the first and second printing data generated by the print-data generating unit, identification information representing a relationship between the first printing data and the second printing data;
a first printing unit that prints the first image represented by the first printing data to the one surface of the recording medium;
a second printing unit that prints an image to a recording medium put on a paper feeding unit; and
an identification-information determining unit that determines, when a print is requested based on printing data for printing to a recording medium put on the paper feeding unit after printing the first image represented by the first printing data to the one surface of the recording medium by the first printing unit, whether or not identification information related to the identification information added to the first printing data is added to the printing data; and
the second printing unit performs a printing as to the printing data for printing to the recording medium put on the paper feeding unit after printing the first image to the one surface of the recording medium by the first printing unit, when the identification-information determining unit determines that the identification information added first printing data is added to the printing data.

16. A storage medium readable by a computer, the storage medium storing a program of instructions executable by the computer to perform a function for printing, the function, comprising:
generating first printing data corresponding to a first image to print to one surface of recording medium and second printing data corresponding to a second image to print to the other surface of the recording medium;
adding, to the first and second printing data, identification information representing a relationship between the first printing data and the second printing data;
printing the first image represented by the first printing data to the one surface of the recording medium;
printing an image to a recording medium put on a paper feeding unit; and
determining, when a print is requested based on printing data for printing to a recording medium put on the paper feeding unit after printing the first image represented by the first printing data to the one surface of the recording medium by the first printing unit, whether or not identification information related to the identification information added to the first printing data is added to the printing data; and
performing a printing as to the printing data for printing to the recording medium put on the paper feeding unit after printing the first image to the one surface of the recording medium by the first printing unit, when the identification-information determining unit determines that the identification information added first printing data is added to the printing data.
